(19) United States
(12) Patent Application Publication
(10) Pub. No.: US 2012/0184690 A1
(43) Pub. Date: Jul. 19, 2012

(54) Method for Continuous Production of Water-Absorbent Polymer Particles

(75) Inventors: Rüdiger Funk, Niedernhausen (DE); Jürgen Schröder, Ludwigshafen (DE)

(73) Assignee: BASF SE, Ludwigshafen (DE)

(21) Appl. No.: 13/498,186

(22) PCT Filed: Oct. 1, 2010
(86) PCT No.: PCT/EP10/64634

§ 371 Date: Mar. 26, 2012

(30) Foreign Application Priority Data
Oct. 9, 2009 (EP) 09172697.6

(51) Int. Cl. C08F 301/00

(52) U.S. Cl. 526/78

(57) ABSTRACT

A process for continuously producing water-absorbing polymer particles, comprising polymerization of a monomer solution or suspension on a continuous belt, drying, grinding, classifying and at least partly recycling the undersize obtained in the classification, wherein the recycled undersize is mixed with the monomer solution or suspension.

The present invention relates to a process for continuously producing water-absorbing polymer particles, comprising polymerization of a monomer solution or suspension on a continuous belt, drying, grinding, classifying and at least partly recycling the undersize obtained in the classification, wherein the recycled undersize is mixed with the monomer solution or suspension.

Being products which absorb aqueous solutions, water-absorbing polymers are used to produce diapers, tampons, sanitary napkins and other hygiene articles, but also as water-retaining agents in market gardening. The water-absorbing polymer particles are also referred to as superabsorbents.

According to the monograph “Modern Superabsorbent Polymer Technology”, F. L. Buchholz and A. T. Graham, Wiley-VCH, 1998, pages 77 to 84, water-absorbing polymers are typically produced in continuous kneading reactors or on continuous belts.

According to EP 1 097 946 A2, overheating in the course of polymerization on continuous belts leads to losses in product quality. The front region of the belt therefore has to be cooled. In the examples, high-concentration monomer solutions are polymerized in thin layers.

According to the monograph “Modern Superabsorbent Polymer Technology”, F. L. Buchholz and A. T. Graham, Wiley-VCH, 1998, pages 95 and 96, water-absorbing polymer particles with excessively small particle size are typically recycled into the process.

EP 0 513 780 A1 describes the recycling of water-absorbing polymer particles by mixing them into the monomer solution. In the examples, low-concentration monomer solutions are polymerized in stirred reactors.

EP 0 454 497 B1 discloses the recycling of the undersize into the monomer solution. The selection of the optimal process conditions is important here. In the examples, polymerization is effected in kneading reactors.

U.S. Pat. No. 5,455,284 teaches the predispersion of the undersize in a portion of the monomer.

It was an object of the present invention to provide an improved process for producing high-quality water-absorbing polymer particles.

The object was achieved by a process for continuously producing water-absorbing polymer particles by polymerizing a monomer solution or suspension comprising
a) at least one ethylenically unsaturated monomer which bears acid groups and may be at least partly neutralized,
b) at least one crosslinker,
c) at least one initiator,
d) optionally one or more ethylenically unsaturated monomers copolymerizable with the monomers mentioned under a) and
e) optionally one or more water-soluble polymers,
   comprising polymerization on a continuous belt, drying, grinding, classifying and at least partly recycling the undersize obtained in the classification into the monomer solution or suspension, wherein the number of ethylenic double bonds in the monomer solution or suspension is at least 4 mol/kg and the layer thickness of the monomer solution or suspension on the continuous belt is at least 5 cm.

In the context of this invention, undersize refers to a particle size fraction which is obtained in the classification and has a lower mean particle size than the particle size fraction of the target product. To remove the undersize, a sieve with a mesh size of up to 250 μm is typically used. The mesh size of the sieve is preferably at least 100 μm, more preferably at least 150 μm, most preferably at least 200 μm.

The number of ethylenic double bonds in the monomer solution or suspension is preferably 4.5 to 9 mol/kg, more preferably 5 to 8 mol/kg, most preferably 5.5 to 7 mol/kg.

The layer thickness of the monomer solution or suspension on the continuous belt is preferably 7 to 20 cm, more preferably 9 to 15 cm, most preferably 10 to 12 cm.

The water content of the monomer solution or suspension is preferably less than 60% by weight, more preferably less than 55% by weight, most preferably less than 50% by weight.

The amount of recycled undersize is preferably from 1 to 30% by weight, more preferably from 3 to 20% by weight, most preferably from 5 to 10% by weight, based in each case on the monomer solution.

The water content of the recycled undersize is preferably less than 8% by weight, more preferably less than 6% by weight, most preferably less than 5% by weight.

The residence time on the belt should preferably at least 15 minutes, more preferably at least 30 minutes, most preferably at least 45 minutes.

With a rising proportion of ethylenic double bonds in the monomer solution or suspension, the heat of polymerization rises and can no longer be removed sufficiently rapidly. The consequence is product damage as a result of overheating of the polymer gel obtained. The present invention is based on the finding that addition of undersize can lower the polymerization rate. The heat of polymerization is released over a longer period and can be removed better. This enables the use of high monomer concentrations in conjunction with high layer thicknesses in the static polymerization.

The water-absorbing polymer particles are produced by polymerizing a monomer solution or suspension and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, preferably at least 10 ppm by weight, more preferably at least 30 ppm by weight, especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraallyloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.05 to 1.5% by weight, more preferably 0.1 to 1% by weight, most preferably 0.3 to 0.6% by weight, based in each case on monomer a). With rising crosslinker content, the centrifuge retention capacity (CRC) falls and the absorption under a pressure of 21.0 g/cm² (AUL0.3 psi) passes through a maximum.

The initiators c) used may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Brüggemann Chemicals; Heilbronn; Germany).

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight, most preferably from 50 to 65% by weight. It is also possible to use monomer suspensions, i.e. oversaturated monomer solutions. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are described, for example, in DE 38 25 366 A1 and U.S. Pat. No. 6,241,928. Polymerization in a belt reactor forms a polymer gel, which may be comminuted in a further process step, for example in a meat grinder, extruder or kneader.

The acid groups of the resulting polymer gels have typically been partially neutralized. Neutralization is preferably carried out at the monomer stage. This is typically done by mixing in the neutralizing agent as an aqueous solution or preferably also as a solid. The degree of neutralization is preferably from 25 to 95 mol %, more preferably from 50 to 80 mol %, most preferably from 60 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably 10 to 30 mol % and more preferably 15 to 25 mol % of the acid groups before the polymerization by adding a portion of the neutralizing agent actually to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt drier until the residual moisture content is preferably 0.5 to 15% by weight, more preferably 1 to 10% by weight, most preferably 2 to 8% by weight, the residual moisture content being determined by EDANA (European Disposables and Nonwovens Association) recommended test method No. WSP 230.2-05 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size (undersize) are obtained. The solids content of the gel before the drying is preferably from 25 to 90% by weight, more preferably from 35 to 70% by weight, most preferably from 40 to 60% by weight. Optionally, it is, however, also possible to use a fluidized bed drier or a paddle drier for the drying operation.

Thereafter, the dried polymer gel is ground and classified, and the apparatus used for grinding may typically be single- or multistage roll mills, preferably two- or three-stage roll mills, pin mills, hammer mills or vibratory mills.

The mean particle size of the polymer particles removed as the product fraction is preferably at least 200 μm, more preferably from 250 to 600 μm, very particularly from 300 to 500 μm. The mean particle size of the product fraction may be determined by means of EDANA (European Disposables and Nonwovens Association) recommended test method No. WSP 220.2-05 “Particle Size Distribution”, where the proportions by mass of the screen fractions are plotted in cumulative form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (undersize) should therefore be small.

Excessively small polymer particles are therefore typically removed and recycled into the process. The excessively small polymer particles can be moistened with water and/or aqueous surfactant before or during the recycling.

It is also possible in later process steps to remove excessively small polymer particles, for example after the surface postcrosslinking or another coating step. In this case, the excessively small polymer particles recycled are surface postcrosslinked or coated in another way, for example with fumed silica.

The proportion of particles having a particle size of at most 850 μm is preferably at least 90% by weight, more preferably at least 95% by weight, most preferably at least 98% by weight.

Polymer particles with too great a particle size lower the swell rate. The proportion of excessively large polymer particles should therefore likewise be small.

Excessively large polymer particles are therefore typically removed and recycled into the grinding of the dried polymer gel.

To further improve the properties, the polymer particles may be surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amidoamines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidone and its derivatives, such as 2-hydroxyethyl-2-oxazolidone in DE 198 07 502 A1, bis- and poly-2-oxazolidinones in DE 198 07 992 C1, 2-oxotetrahydro-1,3-oxazine and its derivatives in DE 198 54 573 A1, N-acyl-2-oxazolidones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and its derivatives in WO 2003/31482 A1.

Preferred surface postcrosslinkers are ethylene carbonate, ethylene glycol diglycidyl ether, reaction products of polyamides with epichlorohydrin, and mixtures of propylene glycol and 1,4-butanediol.

Very particularly preferred surface postcrosslinkers are 2-hydroxyethyloxazolidin-2-one, oxazolidin-2-one and 1,3-propanediol.

In addition, it is also possible to use surface postcrosslinkers which comprise additional polymerizable ethylenically unsaturated groups, as described in DE 37 13 601 A1.

The amount of surface postcrosslinkers is preferably 0.001 to 2% by weight, more preferably 0.02 to 1% by weight, most preferably 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are chloride, bromide, sulfate, hydrogensulfate, carbonate, hydrogencarbonate, nitrate, phosphate, hydrogenphosphate, dihydrogenphosphate and carboxylate, such as acetate, citrate and lactate. Aluminum sulfate is preferred. Apart from metal salts, it is also possible to use polyamines as polyvalent cations.

The amount of polyvalent cation used is, for example, 0.001 to 1.5% by weight, preferably 0.005 to 1% by weight, more preferably 0.02 to 0.8% by weight, based in each case on the polymer particles.

The surface postcrosslinking is typically performed in such a way that a solution of the surface postcrosslinker is sprayed onto the dried polymer particles. After the spraying, the polymer particles coated with surface postcrosslinker are dried thermally, and the surface postcrosslinking reaction can take place either before or during the drying.

The spray application of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; US) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The content of nonaqueous solvent and/or total amount of solvent can be used to adjust the penetration depth of the surface postcrosslinker into the polymer particles.

When exclusively water is used as the solvent, a surfactant is advantageously added. This improves the wetting performance and reduces the tendency to form lumps. However, preference is given to using solvent mixtures, for example isopropanol/water, 1,3-propanediol/water and propylene glycol/water, where the mixing ratio by mass is preferably from 20:80 to 40:60.

The thermal drying is preferably carried out in contact driers, more preferably paddle driers, most preferably disk driers. Suitable driers are, for example, Hosokawa Bepex® horizontal paddle driers (Hosokawa Micron GmbH; Leingarten; Germany), Hosokawa Bepex® disk driers (Hosokawa Micron GmbH; Leingarten; Germany) and Nara paddle driers (NARA Machinery Europe; Frechen; Germany). Moreover, it is also possible to use fluidized bed driers.

The drying can be effected in the mixer itself, by heating the jacket or blowing in warm air. Equally suitable is a downstream drier, for example a shelf drier, a rotary tube oven or a heatable screw. It is particularly advantageous to mix and dry in a fluidized bed drier.

Preferred drying temperatures are in the range of 100 to 250° C., preferably 120 to 220° C., more preferably 130 to 210° C., most preferably 150 to 200° C. The preferred residence time at this temperature in the reaction mixer or drier is preferably at least 10 minutes, more preferably at least 20 minutes, most preferably at least 30 minutes, and typically at most 60 minutes.

Subsequently, the surface postcrosslinked polymer particles can be classified again, excessively small and/or excessively large polymer particles being removed and recycled into the process.

To further improve the properties, the surface postcrosslinked polymer particles can be coated or remoisturized.

The remoisturizing is carried out preferably at 30 to 80° C., more preferably at 35 to 70° C. and most preferably at 40 to 60° C. At excessively low temperatures, the water-absorbing polymer particles tend to form lumps, and, at higher temperatures, water already evaporates noticeably. The amount of water used for remoisturizing is preferably from 1 to 10% by weight, more preferably from 2 to 8% by weight and most preferably from 3 to 5% by weight. The remoisturizing increases the mechanical stability of the polymer particles and reduces their tendency to static charging.

Suitable coatings for improving the swell rate and the permeability (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

The water-absorbing polymer particles produced by the process according to the invention have a moisture content of preferably 0 to 15% by weight, more preferably 0.2 to 10% by weight, most preferably 0.5 to 8% by weight, the water content being determined by EDANA (European Disposables and Nonwovens Association) recommended test method No. WSP 230.2-05 “Moisture Content”.

The water-absorbing polymer particles produced by the process according to the invention have a centrifuge retention capacity (CRC) of typically at least 15 g/g, preferably at least 20 g/g, preferentially at least 22 g/g, more preferably at least 24 g/g, most preferably at least 26 g/g. The centrifuge retention capacity (CRC) of the water-absorbing polymer particles is typically less than 60 g/g. The centrifuge retention capacity (CRC) is determined by EDANA (European Disposables and Nonwovens Association) recommended test method No. WSP 241.2-05 “Centrifuge Retention Capacity”.

The water-absorbing polymer particles produced by the process according to the invention have an absorption under a pressure of 49.2 g/cm² (AUL0.7 psi) of typically at least 15 g/g, preferably at least 20 g/g, preferentially at least 22 g/g, more preferably at least 24 g/g, most preferably at least 26 g/g. The absorption under a pressure of 49.2 g/cm² (AUL0.7 psi) of the water-absorbing polymer particles is typically less than 35 g/g. The absorption under a pressure of 49.2 g/cm² (AUL0.7 psi) is determined analogously to EDANA (European Disposables and Nonwovens Association) recommended test method No. WSP 242.2-05 “Absorption under Pressure”, except that a pressure of 49.2 g/cm² is established instead of a pressure of 21.0 g/cm².

In the process according to the invention, high-quality water-absorbing polymer particles can be produced. The polymer gels obtained as an intermediate can be dried with a low energy input owing to their low water content.

### EXAMPLES

### Example 1

### Noninventive

19.54 g of acrylic acid and 205.01 g of a 37.3% by weight aqueous sodium acrylate solution were weighed into a 1000 ml plastic beaker (internal diameter 105 mm and height 145 mm). While stirring by means of a magnetic crossbeam stirrer, 0.54 g of polyethylene glycol 400 diacrylate (diacrylate of a polyethylene glycol with a molar mass of approx. 400 g/mol) and 15.46 g of water were added. The number of ethylenic double bonds in the monomer solution was 4.4 mol/kg. Subsequently, the plastic beaker was sealed with a polymer film, a PTFE-coated temperature sensor was positioned in the middle of the solution and nitrogen was passed through the solution via a glass frit.

After 30 minutes, 2.15 g of a 10% by weight aqueous solution of 2,2′-azobis(2-methylpropionamidine) dihydrochloride were injected by means of a disposable syringe. After a further 10 minutes, 1.30 g of a 10% by weight aqueous solution of sodium peroxodisulfate and 0.50 g of a 1% by weight aqueous solution of ascorbic acid were injected by means of disposable syringes and the temperature recording was started. The maximum temperature during the polymerization was 102° C. The layer thickness of the monomer solution was 3 cm.

The resulting polymer gel was dried and comminuted to a particle size of less than 150 μm (undersize).

### Example 2

### Noninventive

19.54 g of acrylic acid and 205.01 g of a 37.3% by weight aqueous sodium acrylate solution were weighed into a 1000 ml plastic beaker (internal diameter 105 mm and height 145 mm). While stirring by means of a magnetic crossbeam stirrer, 0.54 g of polyethylene glycol 400 diacrylate (diacrylate of a polyethylene glycol with a molar mass of approx. 400 g/mol) and 15.46 g of comminuted polymer particles (undersize) from example 1 were added. The number of ethylenic double bonds in the monomer solution was 4.4 mol/kg. Subsequently, the plastic beaker was sealed with a polymer film, a PTFE-coated temperature sensor was positioned in the middle of the solution and nitrogen was passed through the solution via a glass frit.

After 30 minutes, 2.15 g of a 10% by weight aqueous solution of 2,2′-azobis(2-methylpropionamidine) dihydrochloride were injected by means of a disposable syringe. After a further 10 minutes, 1.30 g of a 10% by weight aqueous solution of sodium peroxodisulfate and 0.50 g of a 1% by weight aqueous solution of ascorbic acid were injected by means of disposable syringes and the temperature recording was started. The maximum temperature during the polymerization was 87° C. The layer thickness of the monomer solution was 3 cm.

### Example 3

### Noninventive

39.08 g of acrylic acid and 410.02 g of a 37.3% by weight aqueous sodium acrylate solution were weighed into a 1000 ml plastic beaker (internal diameter 105 mm and height 145 mm). While stirring by means of a magnetic crossbeam stirrer, 1.08 g of polyethylene glycol 400 diacrylate (diacrylate of a polyethylene glycol with a molar mass of approx. 400 g/mol) and 30.92 g of water were added. The number of ethylenic double bonds in the monomer solution was 4.4 mol/kg. Subsequently, the plastic beaker was sealed with a polymer film, a PTFE-coated temperature sensor was positioned in the middle of the solution and nitrogen was passed through the solution via a glass frit.

After 30 minutes, 4.30 g of a 10% by weight aqueous solution of 2,2′-azobis(2-methylpropionamidine) dihydrochloride were injected by means of a disposable syringe. After a further 10 minutes, 2.60 g of a 10% by weight aqueous solution of sodium peroxodisulfate and 1.00 g of a 1% by weight aqueous solution of ascorbic acid were injected by means of disposable syringes and the temperature recording was started. The maximum temperature during the polymerization was 106° C. The layer thickness of the monomer solution was 6 cm.

### Example 4

39.08 g of acrylic acid and 410.02 g of a 37.3% by weight aqueous sodium acrylate solution were weighed into a 1000 ml plastic beaker (internal diameter 105 mm and height 145 mm). While stirring by means of a magnetic crossbeam stirrer, 1.08 g of polyethylene glycol 400 diacrylate (diacrylate of a polyethylene glycol with a molar mass of approx. 400 g/mol) and 30.92 g of comminuted polymer particles (undersize) from example 1 were added. The number of ethylenic double bonds in the monomer solution was 4.4 mol/kg. Subsequently, the plastic beaker was sealed with a polymer film, a PTFE-coated temperature sensor was positioned in the middle of the solution and nitrogen was passed through the solution via a glass frit.

After 30 minutes, 4.30 g of a 10% by weight aqueous solution of 2,2′-azobis(2-methylpropionamidine) dihydrochloride were injected by means of a disposable syringe. After a further 10 minutes, 2.60 g of a 10% by weight aqueous solution of sodium peroxodisulfate and 1.00 g of a 1% by weight aqueous solution of ascorbic acid were injected by means of disposable syringes and the temperature recording was started. The maximum temperature during the polymerization was 79° C. The layer thickness of the monomer solution was 6 cm.

The examples demonstrate that overheating in the polymer gel can be prevented by adding undersize to the monomer solution, especially at high layer thicknesses of the monomer solution.

1. A process for continuously producing water-absorbing polymer particles by polymerizing a monomer solution or suspension comprising
a) at least one ethylenically unsaturated monomer which bears an acid group and may be at least partly neutralized,
b) at least one crosslinker,
c) at least one initiator,
d) optionally one or more ethylenically unsaturated monomer copolymerizable with the monomer mentioned under a), and
e) optionally one or more water-soluble polymer, comprising polymerizing on a continuous belt, drying, grinding, classifying, and at least partly recycling undersize particles obtained in the classification into the monomer solution or suspension, wherein a number of ethylenic double bonds in the monomer solution or suspension is at least 4 mol/kg and a layer thickness of the monomer solution or suspension on a continuous belt is at least 5 cm.

2. The process according to claim 1, wherein a water content of the monomer solution or suspension is less than 60% by weight.

3. The process according to claim 1, wherein an amount of recycled undersize, based on the monomer solution, is from 1 to 30% by weight.

4. The process according to claim 1, wherein the recycled undersize particles has a water content of less than 10% by weight.

5. The process according to claim 1, wherein a residence time on the continuous belt is at least 15 minutes.

6. The process according to claim 1, wherein the monomer a) is acrylic acid to an extent of at least 50 mol %.

7. The process according to claim 6, wherein the acrylic acid has been neutralized to an extent of at least 25 mol %.

8. The process according to claim 1, wherein the monomer solution comprises at least 0.01% by weight of crosslinker b), based on monomer a).

9. The process according to 1, wherein the water-absorbing polymer particles have a centrifuge retention capacity of at least 15 g/g.
